(19) United States
(12) Patent Application Publication
(10) Pub. No.: US 2011/0127428 A1
(43) Pub. Date: Jun. 2, 2011

(54) ELECTRON DETECTION SYSTEMS AND METHODS

(75) Inventors: Raymond Hill, Rowley, MA (US); John A. Notte, IV, Gloucester, MA (US)

(73) Assignee: CARL ZEISS NTS, LLC., Peabody, MA (US)

(21) Appl. No.: 12/994,316

(22) PCT Filed: May 26, 2009
(86) PCT No.: PCT/US09/45145

§ 371 Date: Dec. 29, 2010

Related U.S. Application Data
(60) Provisional application No. 61/074,256, filed on Jun. 20, 2008.

(30) Foreign Application Priority Data
Jun. 2, 2008 (US) PCT/US2008/065470

(51) Int. Cl. G01N 23/225

(52) U.S. Cl. 250/307

(57) ABSTRACT

Systems and methods to detect electrons from one or more samples are disclosed. In some embodiments, the systems and methods involve one or more magnetic field sources, for deflecting secondary electrons emitted from the surface of the samples.

### TECHNICAL FIELD

This disclosure relates to systems and methods to detect electrons from one or more samples.

### BACKGROUND

Semiconductor fabrication typically involves the preparation of an article (a semiconductor article) that includes multiple layers of materials sequentially deposited and processed to form an integrated electronic circuit, an integrated circuit element, and/or a different microelectronic device. Such articles typically contain various features (e.g., circuit lines formed of electrically conductive material, wells filled with electrically non-conductive material, regions formed of electrically semiconductive material) that are precisely positioned with respect to each other (e.g., generally on the scale of within a few nanometers). The location, size (length, width, depth), composition (chemical composition) and related properties (conductivity, crystalline orientation, magnetic properties) of a given feature can have an important impact on the performance of the article. For example, in certain instances, if one or more of these parameters is outside an appropriate range, the article may be rejected because it cannot function as desired. As a result, it is generally desirable to have very good control over each step during semiconductor fabrication, and it would be advantageous to have a tool that could monitor the fabrication of a semiconductor article at various steps in the fabrication process to investigate the location, size, composition and related properties of one or more features at various stages of the semiconductor fabrication process. As used herein, the term semiconductor article refers to an integrated electronic circuit, an integrated circuit element, a microelectronic device or an article formed during the process of fabricating an integrated electronic circuit, an integrated circuit element, a microelectronic device. In some embodiments, a semiconductor article can be a portion of a flat panel display or a photovoltaic cell.

Systems and methods for imaging a semiconductor article are known. In many such systems and methods, an ion beam or electron beam impinges on the article, causing particles, such as secondary electrons, to leave the article. The secondary electrons are detected, providing information about the article that is used to obtain an image of the sample.

### SUMMARY

Generally, the disclosure relates to improved methods and systems to detect electrons. Typically, the systems and methods involve interacting a charged particle beam with a sample to cause electrons (e.g., secondary electrons) to leave the sample. The systems and methods can enhance the efficiency with which electrons are detected. The enhanced electron efficiency can provide numerous benefits.

As an example, with the increased electron detection efficiency, it can take less time to develop an image of a sample having a desired resolution. If multiple samples are being sampled (in series or in parallel), the reduced time to obtain the image having the desired resolution can result in a higher throughput process.

As another example, with the increased electron detection efficiency, it can be possible to obtain a relatively high resolution image of a sample. In some instances, particularly where high image resolution is of great importance, the systems and methods disclosed herein can be advantageously used, whereas it may not be possible to successfully use systems and methods that can provide only lower resolution to obtain the desired images.

In some instances, there may be a relatively small distance between the sample and, for example, the end of the ion column of a gas field ion source which is used to create charged particles in the form of an ion beam. In such instances, it may be challenging to detect the electrons of interest. Manipulating the trajectory of the electrons with a magnetic field can enhance the ability to detect the electrons of interest.

In one aspect, the disclosure generally features a method that includes interacting a plurality of first particles with a sample to cause a plurality of second particles to the leave the sample, and exposing the plurality of second particles to a magnetic field to modify the trajectory of the plurality of second particles. The method also includes, after exposing the plurality of second particles to the magnetic field, detecting the plurality of second particles.

In another aspect, the disclosure generally features a system that includes a housing, a first source in the housing, a magnetic field source in the housing and a detector in the housing. The first source is configured to emit a plurality of first particles to a sample so that, during use when the plurality of first particles interacts with the sample, a plurality of second particles leaves the sample. The magnetic field source is configured so that, during use when the plurality of second particles leaves the sample and the magnetic field source is on, the magnetic field source provides a magnetic field that modifies a trajectory of the plurality of second particles. The detector is configured so that, during use after the plurality of second particles interacts with the magnetic field, the detector detects at least some of the plurality of second particles.

In a further aspect, the disclosure generally features a method that includes interacting a plurality of first particles with a sample to cause a plurality of second particles to leave the sample, and exposing the plurality of second particles to a magnetic field to modify the trajectory of the plurality of second particles. The trajectory of the first particles is substantially unaltered by the magnetic field.

In an additional aspect, the disclosure generally features a method that includes interacting a magnetic field with a plurality of secondary electrons leaving a sample. The trajectory of particles that caused the secondary electrons to leave the sample is substantially unaltered by the magnetic field.

In one aspect, the disclosure generally features a method that includes interacting a plurality of first particles with a sample to cause a plurality of second particles to the leave the sample, and exposing the plurality of second particles to a magnetic field to modify the trajectory of the plurality of second particles. The efficiency of the first particles to cause the second particles to leave the sample is substantially unaltered by the magnetic field.

In another aspect, the disclosure generally features a method that includes interacting a magnetic field with a plurality of secondary electrons leaving a sample. The efficiency of particles that caused the secondary electrons to leave the sample is substantially unaltered by the magnetic field.

Other features and advantages will be apparent from the description, drawings, and claims.

### DESCRIPTION OF DRAWINGS

FIG. 1 is a schematic representation of a He ion microscope.

FIG. 2 is a schematic representation of a He ion microscope.

FIG. 3A depicts a trajectory of an electron in a He ion microscope.

FIG. 3B depicts a trajectory of an electron in a He ion microscope.

FIG. 4 is a cross-sectional view of a semiconductor article.

### Like reference symbols in the various drawings indicate like elements.

### DETAILED DESCRIPTION

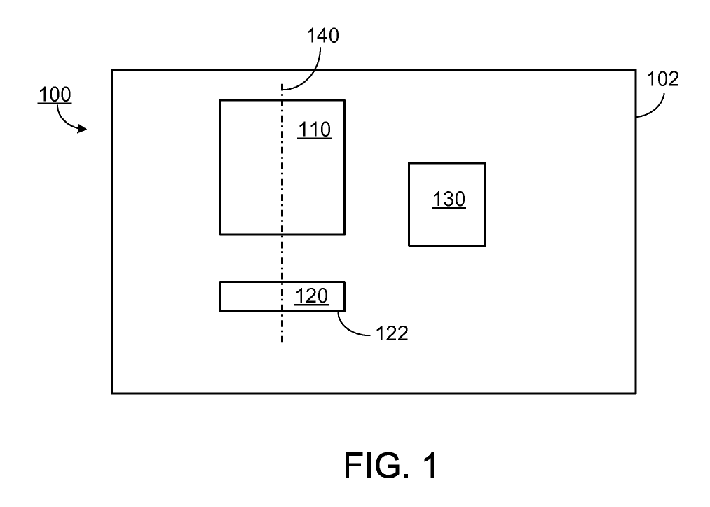

FIG. 1 is a schematic representation of a He ion microscope 100 including a housing 102, a He ion source 110, a semiconductor article 120 and a detector 130 (e.g., an Everhart-Thornley detector). During use, source 110 generates a beam of ions that interacts with a surface 122 (and optionally a subsurface region) of article 120 to cause particles, including electrons, such as secondary electrons (electrons emitted from a sample that have an energy of less than 50 eV), to leave article 120. The electrons are detected with detector 130 to provide information about article 120 which is used to prepare an image of article 120. Typically, detector 130 creates an electrostatic positive extraction field to enhance the ability of the electrons to reach the detector. In some embodiments, the field is at most 0.5 V/mm (e.g., from 0.1 V/mm to 0.5 V/mm).

In some instances, the efficiency with which the electrons are detected can be constrained by practical considerations involving, for example, the arrangement of the components of system 100. For example, ion source 110 typically includes an ion column, the most distal components of which are desirably close to article 120 to enhance the flux of He ions that impinge on article 120, thereby enhancing image resolution and/or throughput. Detector 130 is therefore located off-axis relative to an axis 140 between the He ions generated by source 110 and article 120. This can make it challenging to have detector 130 create an electrostatic extraction field that effectively enhances the detection of electrons from article 120 without negatively impacting the ability of the He ions to impinge on article 120. In other words, in certain cases, by the time the electrostatic potential created by detector 130 is high enough to significantly enhance electron detection, the field may be so high that it impacts the flux and/or location of He ions impinging on article 120, which interferes with the ability to use system 100 to image article 120.

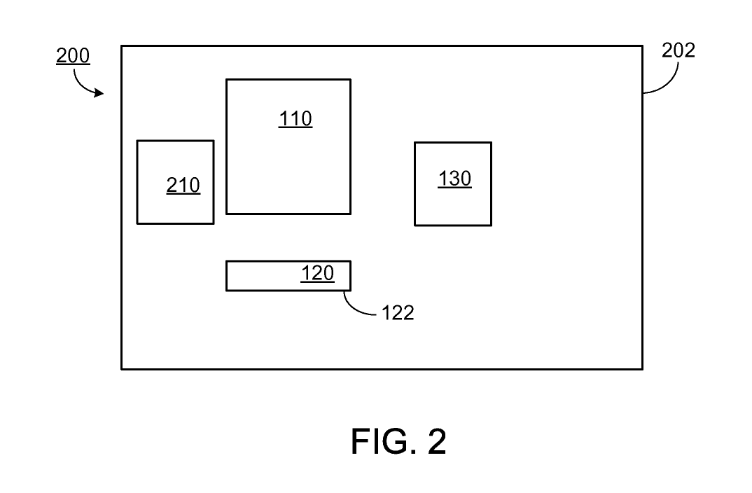

FIG. 2 is a schematic representation of a He ion microscope 200 including a housing 202, source 110, article 120, detector 130 and a magnetic field source 210. In general, source 210 can be any magnetic field source. In some embodiments, source 210 is a permanent magnet. In certain embodiments, source 210 is a wire (e.g., a coiled wire) configured so that, as electrical current passes therethrough, the wire creates a magnetic field. Optionally, source 210 can be a pair of Tesla coils positioned above and below the plane of microscope 200 shown in FIG. 2. In some embodiments, source 210 is a relatively small coil located beneath article 120.

Advantages provided by system 200 can be appreciated when it is realized that the impact of a magnetic field on the trajectory of a positively charged ion can be negligible relative to the impact of the magnetic field on the trajectory of an electron. As an example, it is believed that, under certain conditions, a He ion will be deflected approximately 85 times less than an electron of the same energy in a given magnetic field. With the understanding that the He ions created by source 110 typically have a much greater energy than the electrons to be detected, it is seen that the advantageous effect of the magnetic field is further amplified. In some embodiments, the magnetic field deflects the trajectory of a He ion by an amount that is at least 25 times less (e.g., at least 50 times less, at least 75 times less, at least 100 times less) than the amount by which the magnetic field deflects the trajectory of an electron that is detected.

Thus, by properly selecting the orientation and size of the magnetic field created by source 210, the trajectory of electrons leaving article 120 can be manipulated so that more of the electrons reach detector 130, while at the same time the magnetic field has little or no impact on the interaction of the He ions with article 120. Without wishing to be bound by theory, in some embodiments, the magnitude and/or orientation of the magnetic field can be based on the distance between the distal end of the ion column of source 110 and article 120, the distance between article 120 and detector 130, the angle between detector 130 and a location at article 120 where the electrons leave the sample, the energy of the electrons that are detected, the morphology of the location of article 120 where the electrons leave article 120, and/or the voltage applied to detector 130. It is believed to be within the level of skill in the art to manipulate the appropriate parameters to design a system having the desired properties.

In some embodiments, the magnetic field is perpendicular to surface 122 of article 120. In certain embodiments, the magnetic field is parallel to surface 122 of article 120. Optionally, the magnetic field can be oriented to have an overall vector that is between perpendicular and parallel to surface 122 of article 120.

In certain embodiments, the magnetic field created by source 210 is at least 0.005 Tesla (e.g., at least 0.01 Tesla, at least 0.025 Tesla), and/or at most 0.05 Tesla (e.g., at most 0.04 Tesla, at most 0.03 Tesla). In some embodiments, the magnetic field created by source 210 is from 0.005 Tesla to 0.05 Tesla.

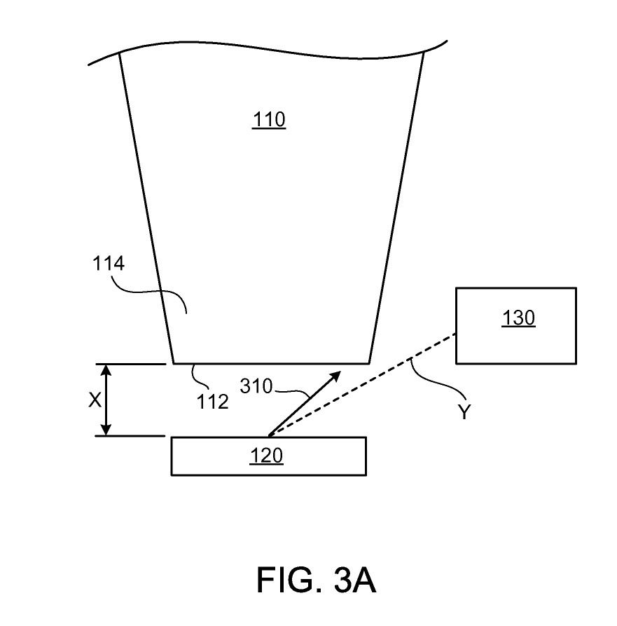

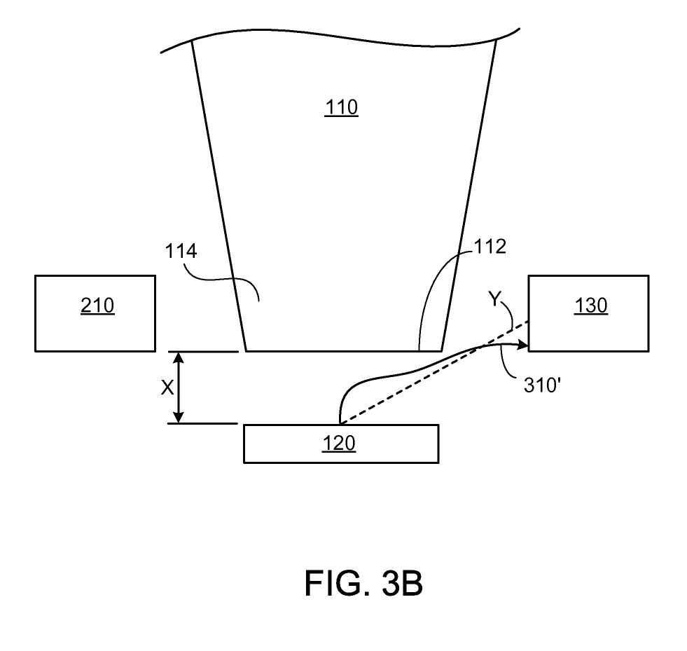

FIGS. 3A and 3B are schematic representations that demonstrate the enhanced ability to detect an electron using a magnetic field. In FIG. 3A, without magnetic field source 210, a trajectory 310 of an electron is such that an end 112 of an ion column 114 of source 110 blocks the electron from reaching detector 130. However, in FIG. 3B, the magnetic field created by source 210 has an orientation (parallel to surface 122 and into the plane of the figure) and magnitude such that the electron follows a trajectory 310′ (which is also impacted by the positive electrostatic field created by detector 130, particularly as electron 320 gets closer to detector 130) and is detected by detector 130.

As shown in FIGS. 3A and 3B, end 112 of ion column 114 is a distance X from a surface 122 of article 120 onto which the He ions impinge. In some embodiments, the distance X is at most 10 millimeters (e.g., at most nine millimeters, at most eight millimeters, at most seven millimeters, at most six millimeters, at most five millimeters, at most four millimeters). In certain embodiments, X is four millimeters to 10 millimeters.

As shown in FIGS. 3A and 3B, detector 130 is a distance Y from the location on surface 122 from electrons that leave article 120. In general, the distance Y can be selected as desired. As an example, in certain instances, the distance Y may be relatively small (e.g., less than 10 millimeters). As another example, such as when using energy and/or trajectory filtering, the distance Y may be relatively large. In some embodiments, the distance Y is at least five millimeters (e.g., at least 10 millimeters, at least 20 millimeters, at least 30 millimeters, at least fifty millimeters), and/or at most 200 millimeters (e.g., at most 150 millimeters, at most 100 millimeters). In certain embodiments, Y is five millimeters to 200 millimeters (e.g., from five millimeters to 100 millimeters, from five millimeters to 50 millimeters).

In some embodiments, the ratio of distance Y to distance X is at least 2:1 (e.g., at least 3:1, at least 4:1, at least 5:1). In certain embodiments, the ratio of distance Y to distance X is from 2:1 to 10:1 (e.g., from 2:1 to 5:1).

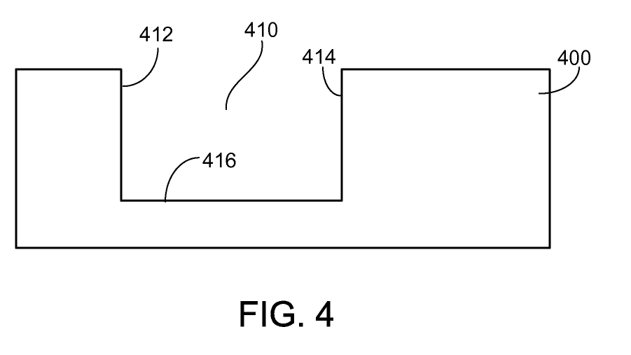

FIG. 4 is a cross-sectional view of a semiconductor article 400 having a cross-section 410 cut therein. Cross-section 410 has sidewalls 412 and 414 and a bottom 416. Such cross-sections are commonly cut into samples when it is desirable to image one or more features that are disposed within the interior of article 400 prior to making the cross-section cut into the sample. After the cross-section is cut, the region of interest may be at or near a portion of article 400 (e.g., sidewall 412, sidewall 414, bottom 416) that is exposed by the cross-section.

Using a system without a magnetic field source, it can be particularly difficult to detect electrons created within cross-section 410 because the foregoing limitations of system 100 are further compounded by the additional problem of getting an electron to have a trajectory which allows it to exit cross-section 410 (e.g., travel substantially along an axis parallel to sidewalls 412 and 414) and to subsequently move off-axis in a fashion that will allow it to reach detector 130. However, by using a system with a magnetic field source and appropriately selecting the orientation and magnitude of the magnetic field, the trajectory of the electron can be manipulated such that it can leave cross-section 410 and be detected by detector 130. Thus, the use of the magnetic field source allows an image to be taken of sidewalls 412 and 414 and/or bottom 416 in less time than would otherwise be available. In some instances, absent the magnetic field source, it may not be possible to take an image of sidewalls 412 and 414 and/or bottom 416 that would be of sufficient resolution.

### Other Embodiments

While certain embodiments have been described, other embodiments are possible.

As an example, while embodiments have been described in which an ion source is a He ion source, other types of gas field ion sources can be used. Examples include Ne ion sources, Ar ion source, Kr ion sources and Xe ion sources.

As another example, while examples have been described in which a gas field ion source is used, other types of ion sources may also be used. In some embodiments, a liquid metal ion source can be used. An example of a liquid metal ion source is a Ga ion source (e.g., a Ga focused ion beam column).

As a further example, while embodiments have been described in which an ion source is used to create ions that impinge on a sample to cause electrons to leave the sample, more generally, any charged particle source may be used. For example, an electron source, such as a scanning electron microscope may be used. In such embodiments, it is to be appreciated that, while the charge to mass ratio of the electrons impinging on the sample is the same as the charge to mass ratio of the detected electrons, the electrons created in the electron source will generally have a substantially higher energy than the detected electrons. Accordingly, the electrons created in the electron source may be deflected by the magnetic field by a smaller amount than the detected electrons.

As an additional example, while embodiments have been described in which samples are in the form of semiconductor articles, in some embodiments, other types of samples can be used. Examples include biological samples (e.g., tissue, nucleic acids, proteins, carbohydrates, lipids and cell membranes), pharmaceutical samples (e.g., a small molecule drug), frozen water (e.g., ice), read/write heads used in magnetic storage devices, and metal and alloy samples. Exemplary samples are disclosed in, for example, US 2007-0158558.

As another example, while embodiments have been described in which secondary electrons are detected, more generally, the disclosure relates to the detection of any type of electron that leaves a sample. In some embodiments, the detected electrons can include Auger electrons. In certain embodiments, the detected electrons have an energy in excess of 50 eV.

As a further example, while embodiments have been described in which an an Everhart-Thornley detector is used, more generally, any type of appropriate electron detector can be used. Examples of electron detectors include microchannel plate detectors, channeltron detectors and solid state detectors.

As yet a further example, while embodiments have been described in which a single electron detector is used, optionally multiple electron detectors (e.g., two, three, four, five, six, etc.) may be used.

As an additional example, while embodiments have been described in which a detector is positioned on the same side of a sample as the charged particle source, in certain embodiments, a detector may be positioned on the opposite side of the sample from the charged particle source. In such embodiments, it may be of interest to detect electrons that are generated by He ions that are transmitted by (e.g., transmitted through) the sample. Such electrons are typically generated on the backside surface of the sample. Optionally, a system may include one or more detectors located on the same side of the sample as the charged particle source, as well as one or more detectors located on the opposite side of the sample relative to the charged particle source.

As another example, in some embodiments, the electrons that are detected pass through at least a portion of (e.g., through the final lens of) the column used to focus the charged particle beam onto the sample. In the case of a gas field ion microscope, this is commonly referred to as the ion column. Because such columns typically include one or more lenses, such detection configurations are often referred to as through lens detectors. In such embodiments, the combination of the electric field used in the column with the magnetic field created by the magnetic field source can be used to control the trajectory of the electrons of interest to enhance their detection. Optionally, multiple magnetic fields can be used. As an example, a first magnetic field can be used to control the trajectory of the electrons such that they are generally directed into the ion column, and a second magnetic field can be used to direct the electrons toward the detector when the electrons are in the column. In some embodiments, an electrostatic field (e.g., created by an element, such as a lens, in the ion column) can be used alone or in conjunction with a second magnetic field source, to direct electrons in the column to the detector.

In some embodiments (whether in the through lens configuration or not), it may be desirable to collect only a subset of the electrons that are caused to leave sample 120. As an example, electrons having only a particular energy or range of energies may be of interest. As another example, electrons having only a particular trajectory or range of trajectories when leaving sample 120 may be of interest. In such embodiments, an electric field may be combined with the magnetic field to achieve this goal. For example, one or more prism detectors, in which an electric and/or magnetic field is used to deflect incident electrons, and where the amount of deflection depends on the energy of the electrons, can be used to spatially separate electrons with different energies so that only electrons with the appropriate energy(ies) are detected by detector 130. Alternatively or additionally, one or more apertures (e.g., located adjacent surface 122) may be used to select detected electrons based on trajectory.

As another example, while embodiments have been described in which a magnetic field source is located on the same side of the sample as the charged particle source, in some embodiments, the magnetic field source can be located on the opposite side of the sample relative to the charged particle source.

As a further example, while embodiments have been described in which one magnetic field source is used, in some embodiments, multiple magnetic field sources (e.g., two, three, four, five, six, etc.) can be used. Optionally, a system may include one or more magnetic field source located on the same side of the sample as the charged particle source, as well as one or more magnetic field source located on the opposite side of the sample relative to the charged particle source.

As an additional example, while embodiments have been described in which one or more magnetic fields are used to direct electrons along a particular trajectory, in some embodiments, one or more electrostatic field sources may be used in combination with one or more magnetic field sources.

It will be appreciated that various combinations of the features disclosed herein can be used.

Other embodiments are covered by the claims.

1-68. (canceled)

69. A method, comprising:
interacting a plurality of first particles with a sample to cause a plurality of second particles to the leave the sample;
selecting a magnitude and/or an orientation of a magnetic field based on at least one parameter selected from the group consisting of a distance between a source of the plurality of first particles and the sample, a distance between the sample and a detector used to detect the second particles, an angle between the detector used to detect the second particles and a location at the sample where the second particles leave the sample, an energy of the second particles, a morphology of a location at the sample where the second particles leave the sample, and a voltage applied to the detector;
exposing the plurality of second particles to the magnetic field to modify a trajectory of the plurality of second particles; and
after exposing the plurality of second particles to the magnetic field, detecting the plurality of second particles.

70. The method of claim 69, wherein the first particles are ions.

71. The method of claim 70, wherein the plurality of first particles is in the form of a beam.

72. The method of claim 71, wherein the beam of the plurality of first particles is generated by a gas field ion source.

73. The method of claim 72, wherein the gas field ion source includes an ion column, and at least some of the plurality of second particles pass through at least a portion of the ion column before being detected.

74. The method of claim 69, wherein exposing the plurality of second particles to the magnetic field increases a detection efficiency of the plurality of second particles relative to a detection efficiency of the plurality of second particles that would be achieved in the absence of the magnetic field.

75. The method of claim 69, wherein at least some of the plurality of second particles leave the sample from a location where the sample is in the shape of a hole.

76. The method of claim 69, wherein the second particles are electrons.

77. The method of claim 76, wherein the second particles are secondary electrons.

78. The method of claim 69, wherein the magnitude of the magnetic field is at least 0.005 Tesla.

79. A method, comprising:
interacting a plurality of first particles with a sample to cause a plurality of second particles to the leave the sample;
selecting a magnitude and/or an orientation of a magnetic field based on at least one parameter selected from the group consisting of a distance between a source of the plurality of first particles and the sample, a distance between the sample and a detector used to detect the second particles, an angle between the detector used to detect the second particles and a location at the sample where the second particles leave the sample, an energy of the second particles, a morphology of a location at the sample where the second particles leave the sample, and a voltage applied to the detector; and
exposing the plurality of second particles to the magnetic field to modify a trajectory of the plurality of second particles,
wherein a trajectory of the first particles is substantially unaltered by the magnetic field.

80. A method, comprising:
interacting a plurality of first particles with a sample to cause a plurality of second particles to the leave the sample;
selecting a magnitude and/or an orientation of a magnetic field based on at least one parameter selected from the group consisting of a distance between a source of the plurality of first particles and the sample, a distance between the sample and a detector used to detect the second particles, an angle between the detector used to detect the second particles and a location at the sample where the second particles leave the sample, an energy of the second particles, a morphology of a location at the sample where the second particles leave the sample, and a voltage applied to the detector; and
exposing the plurality of second particles to the magnetic field to modify a trajectory of the plurality of second particles,
wherein an efficiency of the first particles to cause the second particles to leave the sample is substantially unaltered by the magnetic field.

81. A method, comprising:
interacting a magnetic field with a plurality of secondary electrons leaving a sample, and selecting a magnitude and/or an orientation of the magnetic field based on at least one parameter selected from the group consisting of a distance between a source of the plurality of first particles and the sample, a distance between the sample and a detector used to detect the second particles, an angle between the detector used to detect the second particles and a location at the sample where the second particles leave the sample, an energy of the second particles, a morphology of a location at the sample where the second particles leave the sample, and a voltage applied to the detector,
wherein a trajectory of particles that caused the secondary electrons to leave the sample is substantially unaltered by the magnetic field.

82. The method of claim 81, wherein the modified trajectory of the plurality of second particles passes at least partially through an ion column of a gas field ion system.

83. The method of claim 81, wherein the electrons are exposed to a second magnetic field to direct the electrons in the ion column.

84. The method of claim 81, wherein the first particles are ions.

85. The method of claim 84, wherein the plurality of first particles is in the form of a beam.

86. The method of claim 85, wherein the beam of the plurality of first particles is generated by a gas field ion source.

87. The method of claim 86, wherein the gas field ion source includes an ion column, and at least some of the plurality of second particles pass through at least a portion of the ion column before being detected.

88. A method, comprising:
interacting a magnetic field with a plurality of secondary electrons leaving a sample,
selecting a magnitude and/or an orientation of the magnetic field based on at least one parameter selected from the group consisting of a distance between a source of the plurality of first particles and the sample, a distance between the sample and a detector used to detect the second particles, an angle between the detector used to detect the second particles and a location at the sample where the second particles leave the sample, an energy of the second particles, a morphology of a location at the sample where the second particles leave the sample, and a voltage applied to the detector;
wherein an efficiency of particles that caused the secondary electrons to leave the sample is substantially unaltered by the magnetic field.
